(19) United States
(12) Patent Application Publication
(10) Pub. No.: US 2025/0158469 A1
(43) Pub. Date: May 15, 2025

(54) STATOR FOR AN ELECTRICAL MACHINE, ELECTRICAL MACHINE, AND VEHICLE

(71) Applicant: Valeo eAutomotive Germany GmbH, Erlangen (DE)

(72) Inventor: Boris DOTZ, Bad Neustadt a.d.Saale (DE)

(73) Assignee: Valeo eAutomotive Germany GmbH, Erlangen (DE)

(21) Appl. No.: 18/722,962

(22) PCT Filed: Dec. 19, 2022
(86) PCT No.: PCT/EP2022/086673

§ 371 Date: Aug. 8, 2024

(30) Foreign Application Priority Data
Dec. 22, 2021 (EP) 21217167.2

(51) Int. Cl. H02K 3/28; H02K 1/16

(52) U.S. Cl. CPC H02K 3/28; H02K 1/16; H02K 2213/03

(57) ABSTRACT

A stator for an electrical machine includes: a stator core which has a longitudinal axis, an end side, a further end side opposite the end side and a plurality of slots arranged in the circumferential direction and extending from the end side to the further end side, and a stator winding which has a number N of strands, in which N≥3. Each strand occupies a plurality of winding zones in the slots and has at least one continuous current path with a first end and with a second end opposite the first end.

The present invention relates to a stator for an electrical machine, comprising a stator core which has a longitudinal axis, an end side, a further end side opposite the end side and a plurality of slots arranged in the circumferential direction and extending from the end side to the further end side, and a stator winding which has a number N of strands, wherein N≥3, wherein each strand occupies a plurality of winding zones in the slots and has at least one continuous current path with a first end and with a second end opposite the first end, wherein each winding zone is radially divided into first to L-th layers, which are named according to their order in the radial direction, wherein the layers form first to (L/2)-th double layers, wherein the i-th double layer comprises the (2i−1)-th layer and the (2i)-th layer for every 1≤i≤(L/2), wherein L≥4 and is straight, wherein the j-th double layer is offset in relation to the (j−1)-th double layer for every 2≤j≤(L/2) by a slot along a predetermined circumferential direction, wherein N, L, i and j are natural numbers.

In addition, the invention relates to an electrical machine and a vehicle.

A stator for a three-phase motor with a stator core and a plurality of slots defined in the stator housing is known from CN 109 038 878 A. Stator windings are arranged in six layers in the slots. At least two adjacent layers are displaced by one slot.

In the case of stators for an electrical machine, a low construction height, which saves on material and the associated costs, is sought. Accordingly, a symmetrically wound stator winding with a low winding overhang on the end sides is sought. In addition, a simple connection of the strands to the power supply is advantageous. Furthermore, automated production with high process reliability is intended to be made possible. Also, low resistive losses along the current paths are desirable in order to be able to operate the stator efficiently. A good symmetry of the stator winding is also sought.

The invention is based on the object of specifying an improved option for operating an electrical machine for a vehicle.

This object is achieved according to the invention in a stator of the type mentioned at the beginning in that the current path forms a combined wave and lap winding extending over all of the double layers.

The stator according to the invention for an electrical machine has a stator core. The stator core has a longitudinal axis, an end side, a further end side and a plurality of slots. The further end side is situated opposite the end side. The slots are arranged in the circumferential direction. The slots extend from the end side to the further end side. The stator furthermore has a stator winding. The stator winding has a number N of strands, wherein N≥3. Each strand occupies a plurality of winding zones in the slots. Each strand has at least one continuous current path. The current path has a first end and a second end opposite the first end. Each winding zone is radially divided into first to L-th layers. The layers are named according to their order in the radial direction. The layers form first to (L/2)-th double layers. The i-th double layer comprises the (2i−1)-th and the (2i)-th layer for every 1≤i≤(L/2), wherein L≥4 and is straight. The j-th double layer is offset in relation to the (j−1)-th double layer for every 2≤j≤(L/2) by a slot along a predetermined circumferential direction. N, L, i and j are natural numbers. The current path forms a combined wave and lap winding. The combined wave and lap winding extends over all the double layers.

The combined wave and lap winding, in which the current path occupies each double layer in two winding zones which are adjacent in the circumferential direction and is then continued in the circumferential direction in a further adjacent winding zone, permits, in conjunction with the offset double layers, a shortening of at least a portion of the connections between the winding zones. As a result, the current path can be kept short at least in sections, thus giving rise to only small resistive losses. A stator which can be operated energy-efficiently for an electrical machine is thus formed. In addition, the offset results in an improvement in the torque response, in particular the torque ripple, of the electrical machine. In particular, the noise and vibration behavior can thereby be improved.

The stator core is typically formed from a plurality of axially layered and/or mutually insulated individual laminations. To this extent, the stator core may also be referred to as a laminated stator core. Portions of the current path belonging exclusively to the same strand are typically arranged in each winding zone.

Preferably, the number of strands is precisely three or precisely six. Particularly preferably, the number of layers is precisely six or precisely eight or precisely ten. Preferably, the first layer is the radially innermost or the radially outermost layer. The predetermined circumferential direction may also be understood or referred to as the predetermined orientation of the circumferential direction. The predetermined circumferential direction may be clockwise or counter-clockwise, looking at the end side.

The stator winding may have at least four, preferably at least six poles, particularly preferably at least eight poles. Preferably, the number of poles is precisely four or precisely six or precisely eight. Preferably, the number of winding zones occupied by a respective strand in the slots corresponds to twice the number of pole pairs.

A total of at least twenty-four, preferably at least thirty-six, particularly preferably at least fifty-four slots may be provided. The number of slots can be precisely twenty-four, precisely thirty-six, precisely forty-eight, precisely fifty-four or precisely seventy-two.

Particularly preferably, the current path is formed by a plurality of connecting portions of the first type, which are arranged on the end side, a plurality of connecting portions of the second type, which are arranged on the further end side, and a plurality of inner portions, which are arranged within the slots and are connected in series by means of the connecting portions.

In order to form the stator winding as a shaped conductor or hairpin winding, each current path can be formed by shaped conductors. Shaped conductors can be provided which form two of the inner portions and a connecting portion of the first type connecting the two inner portions. In each case two of the shaped conductors can form a connecting portion of the second type on the further end side by being connected to each other electrically conductively and mechanically, in particular in an integrally bonded manner. In particular, each shaped conductor is formed from a multiply bent metal rod. Preferably, each shaped conductor is formed from copper. Typically, each layer in each slot forms a receiving location for precisely one inner portion.

Preferably, the shaped conductors can have a rectangular cross section or a rectangular cross section with rounded corners.

In a preferred refinement, each connecting portion of the first type connects two inner portions, which are arranged in different double layers, in series.

It is also preferred that each connecting portion of the second type connects an inner portion, which is arranged in an even-numbered layer, in series with an inner portion, which is arranged in an odd-numbered layer and follows the inner portion, which is arranged in the even-numbered layer, along the predetermined circumferential direction or along a circumferential direction opposite the predetermined circumferential direction. This makes it possible for each connecting portion of the second type to either run radially inward or radially outward, and therefore, by means of a uniform radial extent, the manufacturing complexity is reduced. In particular, when the connecting portions of the second type are formed by two of the shaped conductors, a simply designed tool can be used to realize a corresponding bending of free ends of the metal rods in order to form the connecting portions of the second type. Typically, the even-numbered layer and the odd-numbered layer, in which layers the inner portions which are connected in series by the connecting portion of the second type are arranged, belong to one and the same double layer.

In an advantageous refinement, it may also be provided that the ends of the current path are arranged in winding zones which are adjacent with respect to the circumferential direction. This allows the two ends to be led out of the stator core close together in order to be connected to a power supply.

It is also preferred that a first and a second current path are provided for each strand. These current paths can then be connected in parallel or in series, as also described in detail below. Preferably, an inner portion of the first current path and an inner portion of the second current path are arranged in each double layer of the same slot.

In particular, the first end of the first current path and the first end of the second current path are located in the same slot. The first end of the first current path and the first end of the second current path can also be located in the same double layer.

Furthermore, the second end of the first current path and the second end of the second current path can be located in different, in particular directly adjacent, slots. In addition, the second end of the first current path and the second end of the second current path can be located in different, in particular directly adjacent, double layers.

Preferably, the stator furthermore comprises a star-point connection and, for each strand, a phase connection. The stator may also have a further star-point connection.

According to a first refinement alternative, the first ends of the current paths of a respective strand are connected to the phase connection for the respective strand. It is possible that the second end of a respective current path of a respective strand is connected to the star-point connection, or that the second end of the first current path of a respective strand is connected to the star-point connection, and the second end of the second current path of a respective strand is connected to the further star-point connection. Thus, parallel current paths with one star point or two star points can be formed by the outer wiring of the current paths.

According to a second alternative refinement, the current paths of a respective strand are connected in series. One of the ends of the first current path of a respective strand can be connected to the phase connection for the strand. One of the ends of the second current path of a respective strand can be connected to the star-point connection. The remaining ends of the current paths can be connected to each other.

In an advantageous refinement, a good symmetry of the stator winding can be achieved if the first current path and the second current path extend from the first end to the second end in opposite circumferential directions about the stator core.

Preferably, each winding zone is divided in the circumferential direction into first to q-th partial winding zones which each comprise all of the layers and are named according to their order in the circumferential direction, in particular their order counter to the predetermined circumferential direction. The current path has first to q-th partial windings, which are connected in series in the order of their naming, wherein q≥2 and is a natural number. The partial windings can be arranged in different partial winding zones, in particular the k-th partial winding in the k-th partial winding zone for every 1≤k≤q. k is a natural number.

In a preferred refinement, each partial winding forms a full revolution about the stator core.

Preferably, it is furthermore provided that in one of the minimum of one current path, in particular in the first current path, a respective partial winding comprises a set of first to P-th conductor sequences of the first type, which follow one another in the order of their naming with respect to the current path and are arranged in each case in two directly adjacent winding zones. It may be provided that each conductor sequence of the first type comprises first to (L/2)-th pairs of a first of the inner portions and a second of the inner portions and the pairs are named according to their order along the current path. In a preferred development, the first and second inner portions are arranged in different layers of the double layer corresponding to the naming of the pair. Furthermore, the first to (P−1)-th conductor sequences of the first type can be connected by one of the connecting portions, in particular the connecting portions of the first type, to the conductor sequence of the first type following along the current path and the following conductor sequence of the first type can be arranged in two directly adjacent winding zones.

In the conductor sequences of the first type, a distance between the inner portions of the first to (L/2)-th pair is preferably N·q. Thus, a uniform jump width between the inner portions connected by the connectors of the second type can advantageously be formed by the latter.

A distance between the second inner portion of the a-th pair and the first inner portion of the (a+1)-th pair is preferably N·q−1 for all natural numbers 1≤a≤(L/2)−1. A distance between the second inner portion of the (L/2)-th pair of the b-th conductor sequence of the first type and the first inner portion of the first pair of the (b+1)-th conductor sequence of the first type is preferably N q−2 for all natural numbers 1≤b≤P−1. A distance between the second inner portion of the (L/2)-th pair of the P-th conductor sequence of the first type of the c-th partial winding and the first inner portion of the first pair of the first conductor sequence of the first type of the (c+1)-th partial winding is preferably N q−3 for all natural numbers 1≤c≤q−1. Since the jump widths here are clearly smaller than N q, the length of the current path having conductor sequences of the first type can be reduced in order to keep resistive losses low.

Preferably, it is furthermore provided that in one of the minimum of one current path, in particular in the second current path, a respective partial winding comprises a set of first to P-th conductor sequences of the second type, which follow one another in the order of their naming with respect to the current path and are arranged in each case in first to fourth directly adjacent winding zones. It is preferred that each conductor sequence of the second type comprises first to (L/2)-th pairs of a first of the inner portions, and a second of the inner portions, and the pairs are named according to their order along the current path, wherein the first and second inner portions are arranged in different layers of the same double layer. Preferably, it is provided that the first pair is arranged in the first double layer, wherein the second pair is arranged in the (L/2)-th double layer, wherein the third pair is arranged in the second double layer or the third to (L/2)-th pairs are arranged in the second to [(L/2)−1]-th double layer. Preferably, it is provided that the third winding zone, in which the inner portions of the first to (P−1)-th conductor sequences of the second type are arranged, is the first winding zone, in which the conductor sequence following the conductor sequence with respect to the current path is arranged, and/or that the fourth winding zone, in which the inner portions of the first to (P−1)-th conductor sequences of the second type are arranged, is the second winding zone, in which the conductor sequence of the second type following the conductor sequence with respect to the current path is arranged.

In the conductor sequences of the second type, a distance between the inner portions of the first to (L/2)-th pair is preferably N·q. Thus, a uniform jump width between the inner portions connected by the connectors of the second type can advantageously be formed by the latter.

A distance between the second inner portion of the first pair and the first inner portion of the second pair is preferably N·q−2. A distance between the second inner portion of the d-th pair and the first inner portion of the (d+1)-th pair is preferably N·q−1 for all natural numbers 2≤d≤(L/2)−1. A distance between the second inner portion of the (L/2)-th pair of the e-th conductor sequence of the first type and the first inner portion of the first pair of the (e+1)-th conductor sequence of the first type is preferably N·q−1 for all natural numbers 1≤e≤P−1. A distance between the second inner portion of the (L/2)-th pair of the P-th conductor sequence of the first type of the f-th partial winding and the first inner portion of the first pair of the first conductor sequence of the first type of the (f+1)-th partial winding is preferably N q−2 for all natural numbers 1≤f≤q−1. Since the jump widths here are clearly smaller than N q, the length of the current path having conductor sequences of the second type can be reduced in order to keep resistive losses low.

P describes in particular the number of pole pairs of the stator winding. The natural number q can describe the number of holes or the number of slots per pole and phase. In particular, the number of slots is 2·N·q·P.

The object on which the invention is based is furthermore achieved by an electrical machine having a stator according to the invention and a rotor mounted rotatably relative to the stator. The electrical machine is preferably an, in particular permanently or electrically excited, synchronous machine. The electrical machine may also be an induction machine. Preferably, the electrical machine is configured for driving a vehicle.

The object on which the invention is based is furthermore achieved by a vehicle, comprising a machine according to the invention, wherein the electrical machine is configured for driving the vehicle. The vehicle can be a battery-electric vehicle (BEV) or a hybrid vehicle.

Further advantages and details of the present invention are apparent from the exemplary embodiments described below and with reference to the drawings. The latter are schematic illustrations and:

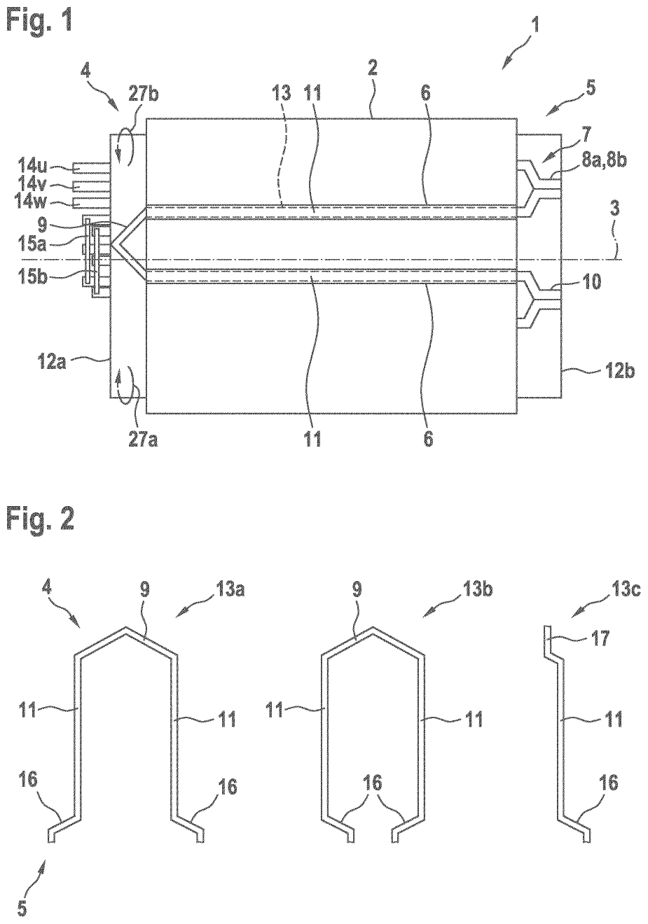

FIG. 1 shows a schematic diagram of a first exemplary embodiment of the stator according to the invention;

FIG. 2 shows a schematic diagram of shaped conductors according to the first exemplary embodiment;

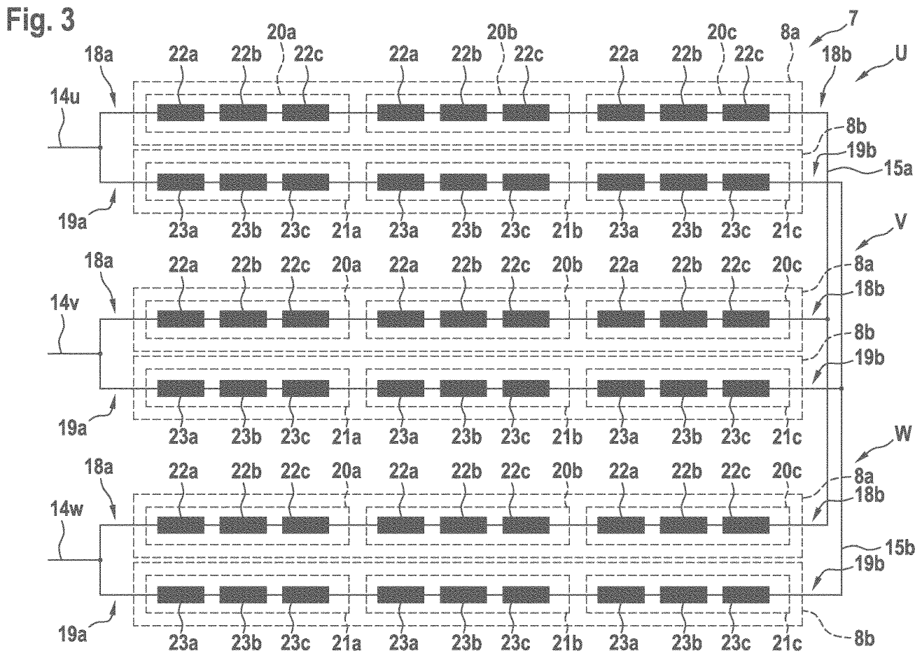

FIG. 3 shows a block circuit diagram of the stator winding according to the first exemplary embodiment;

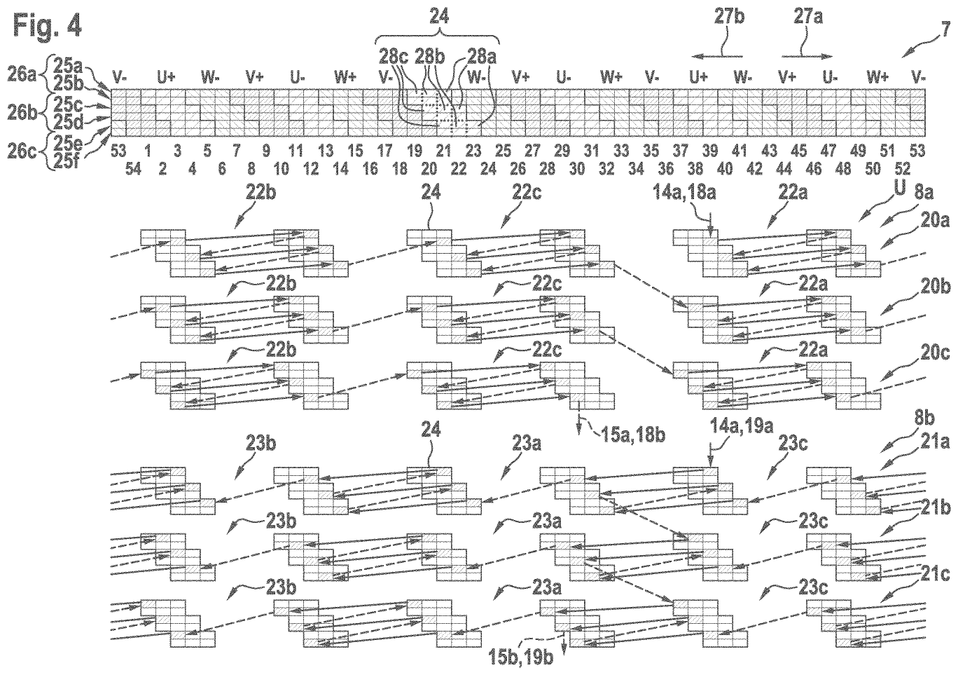

FIG. 4 shows a winding diagram of the stator winding according to the first exemplary embodiment;

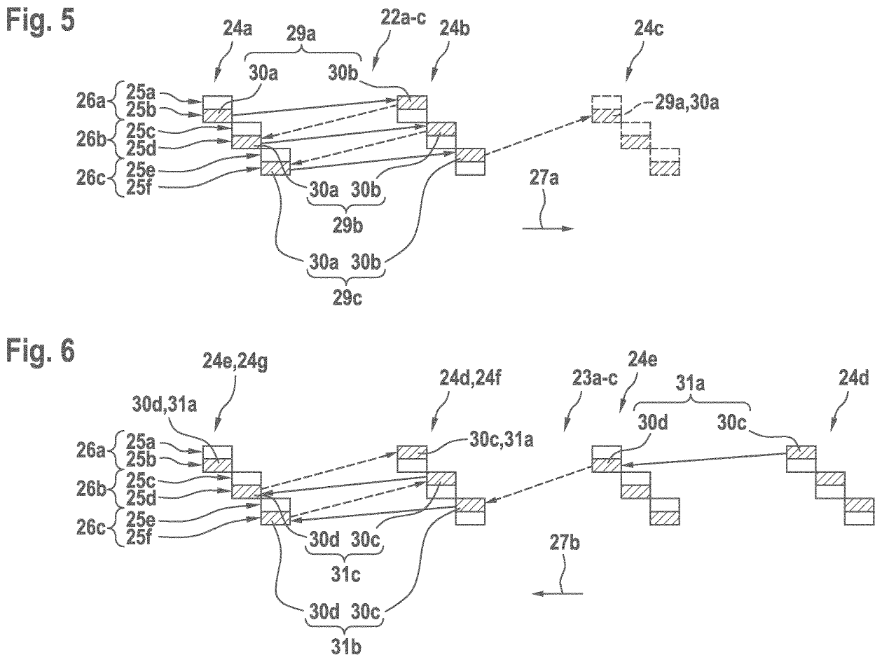

FIG. 5 shows a detailed view of a conductor sequence of the first type;

FIG. 6 a detailed view of a conductor sequence of the second type;

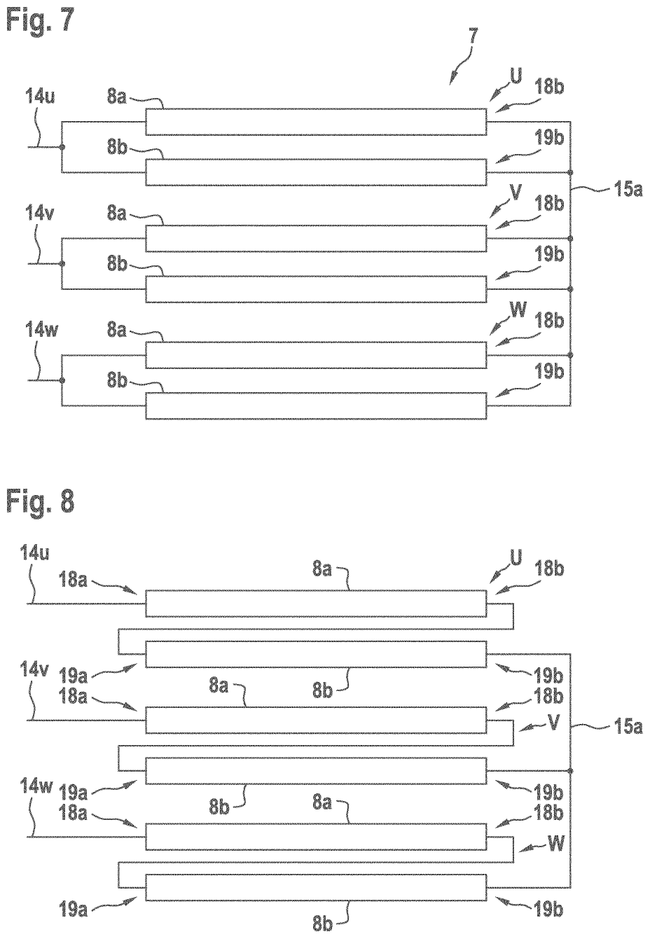

FIG. 7 shows a block circuit diagram of the stator winding according to a second exemplary embodiment of the stator according to the invention;

FIG. 8 shows a block circuit diagram of the stator winding according to a third exemplary embodiment of the stator according to the invention; and

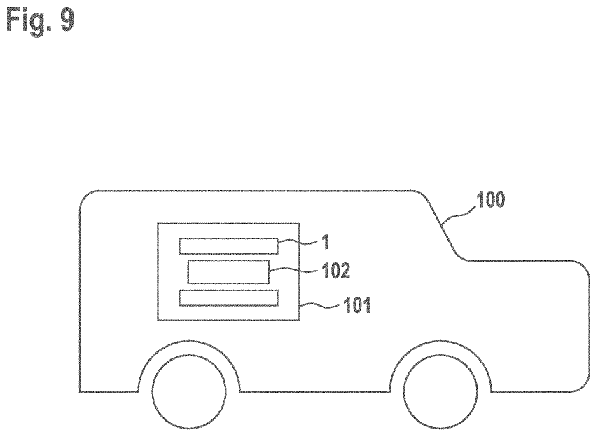

FIG. 9 shows a schematic diagram of an exemplary embodiment of the vehicle according to the invention with an exemplary embodiment of the electrical machine according to the invention.

FIG. 1 is a schematic diagram of a first exemplary embodiment of a stator 1.

The stator 1 has a stator core 2. The stator core 2 has a longitudinal axis 3, an end side 4 and a further end side 5 opposite the end side 4. Furthermore, the stator core 2 has a plurality of slots 6 arranged in the circumferential direction, of which only two are shown in the schematic diagram according to FIG. 1 for reasons of clarity. Each slot 6 extends axially from the end side 4 to the further end side 5. In the present exemplary embodiment, the stator core 2 is formed by way of example from a plurality of axially layered and mutually insulated individual laminations (not shown). To this extent, the stator core 2 may also be regarded as a laminated stator core.

The stator 1 furthermore has a stator winding 7 with a number N=3 strands U, V, W (compare FIG. 3). Each strand has two current paths 8a, 8b, which are also illustrated only purely schematically in FIG. 1. In this exemplary embodiment, a respective current path 8a, 8b is formed by a plurality of connecting portions 9 of the first type, which are arranged on the end side 4, a plurality of connecting portions 10 of the second type, which are arranged on the further end side 5, and a plurality of inner portions 11, which are arranged within the slots 6. The inner portions 11 are connected in series by the connecting portions 9, 10. In this case, the first connecting portions 9 form a winding head 12a on the end side 4 and a further winding head 12b on the further end side 5.

In the present exemplary embodiment, the stator winding 7 is designed by way of example as shaped conductor windings or a hairpin winding. Shaped conductors 13 are provided for this purpose. The stator 1 also has a phase connection 14u, 14v, 14w for each strand U, V, W. In addition, a star-point connection 15a and a further star-point connection 15b are provided.

FIG. 2 is a schematic diagram of shaped conductors 13a, 13b, 13c according to the first exemplary embodiment.

The shaped conductors 13, which are illustrated only schematically in FIG. 1, comprise shaped conductors 13a of the first type, which form two of the inner portions 11 and one of the connecting portions 9 of the first type. In each case two of the shaped conductors 13a, 13b, 13c form one of the connecting portions 10 of the second type on the further end side 5 by being connected to each other electrically conductively and mechanically and in an integrally bonded manner. For this purpose, an end portion 16 is connected to each inner portion 11, which end portion is connected to the end portion 16 of another shaped conductor 13a, 13b, 13c in order to form the connecting portion 10 of the second type. In the case of the shaped conductors 13a of the first type, the end portions 16 point away from each other with respect to the circumferential direction. The shaped conductors 13b of the second type are designed in the manner of the shaped conductors 13a of the first type, with the end portions 16, however, facing each other in the circumferential direction.

The shaped conductors 13c of the third type form only an inner portion 11 and, on the further end side 5, have only one end portion 16 adjoining the portion 11. On the end side 4, the shaped conductors 13c of the third type have a connection portion 17 which adjoins the portion 11. The connection portions 17 of the shaped conductors 13c of the third type form the phase connections 14u, 14v, 14w (see FIG. 1) and are connected to each other by means of the star-point connections 15a, 15b to form two star points.

The shaped conductors 13, 13a, 13b, 13c are each formed in one piece from a multiply bent copper rod.

FIG. 3 is a block circuit diagram of the stator winding 7 according to the first exemplary embodiment.

The first current path of a respective strand U, V, W has a first end 18a and a second end 18b. The second current path 8b has a first end 19a and a second end 19b. The second end 18b, 19b of a respective current path 8a, 8b lies opposite the first end 18a, 19 of the respective current path 8a, 8b.

In the present exemplary embodiment, the first ends 18a, 19a of the current paths 8a, 8b of a respective strand U, V, W are connected to the phase connection 14u, 14v, 14w of the respective strand U, V, W. The second end 18b of a respective first current path 8a of a respective strand U, V, W is connected to the star-point connection 15a. The second end 19b of the second current path 8b of a respective strand U, V, W is connected to the further star-point connection 15b. Two star points of the stator winding 7 are formed as a result.

The first current path 8a has q=3 partial windings, namely a first partial winding 20a, a second partial winding 20b and a third partial winding 20c. The partial windings 20a, 20b, 20c are connected in series according to their naming. The second current path 8b has q=3 partial windings, namely a first partial winding 21a, a second partial winding 21b and a third partial winding 21c. The partial windings 21a, 21b, 21c are connected in series according to their naming.

Each partial winding 20a, 20b, 20c of the first current path 8a has P=3 conductor sequences of the first type, namely a first conductor sequence 22a of the first type, a second conductor sequence 22b of the first type and a third conductor sequence 22c of the first type. The conductor sequences 22a, 22b, 22c of the first type are connected in series according to their naming. The first to (P−1)-th conductor sequences 22a, 22b of the first type are connected by a connecting portion 9 of the first type to the conductor sequence 22b, 22c of the first type following along the first current path 8a and are arranged in two directly adjacent winding zones 24.

Each partial winding 21a, 21b, 21c of the second current path has P=3 conductor sequences of the second type, namely a first conductor sequence 23a of the second type, a second conductor sequence 23b of the second type and a third conductor sequence 23c of the second type. The conductor sequences 23a, 23b, 23c of the second type are connected in series according to their naming.

FIG. 4 is a winding diagram of the stator winding 7 according to the first exemplary embodiment. An upper table shows the distribution of winding zones 24 to the slots 6, wherein the winding zones 24 are marked with different hatching for each strand U, V, W. A plus sign or a minus sign after a respective naming of the strands U, V, W indicates a current direction during operation of the stator 1. A numbering of the slots 6 is shown below the upper table. Below them, the current paths 8a, 8b of one of the strands, here the strand U, are illustrated by way of example for the remaining strands U, V, W.

As can be seen from FIG. 4, each strand occupies 2·P=6 winding zones 24 in the slots 6. The number of 2·P corresponds to the number of poles of the stator winding 7. Each winding zone 24 is radially divided into L=6 layers, namely a first layer 25a, a second layer 25b, a third layer 25c, a fourth layer 25d, a fifth layer 25e and a sixth layer 25f. The layers 25a-f are named according to their order in the radial direction. By way of example, the first layer 25a lies radially on the outside. In each slot 6, a layer 25a-f forms a receiving location for precisely one inner portion 11 of the stator winding 7.

The layers 25a-f furthermore form L/2=3 double layers, namely a first double layer 26a, a second double layer 26b and a third double layer 26c. The first double layer 26a comprises the first and second layers 25a, 25b, the second double layer 26b comprises the third and fourth layers 25c, 25d and the third double layer 26c comprises the fifth and sixth layers 25e, 25f. Generally speaking, the i-th double layer 26a-c comprises the (2i−1)-th and the (2i)-th layer 25a-f for every 1≤i≤(L/2), wherein i is a natural number.

The second double layer 26b is offset from the first double layer 26a by a slot 6 along a predetermined circumferential direction 27a which corresponds in this case by way of example to the clockwise direction, looking at the first end side 4 (see also FIG. 1). Furthermore, the third double layer 26c is offset from the second double layer 26b by a slot 6 along the predetermined circumferential direction 27a. Generally speaking, the j-th double layer 26b, 26c is offset from the (j−1)-th double layer 26a, 26b for every 2≤j≤(L/2) by a slot 6 along the predetermined circumferential direction 27a, wherein j is a natural number.

The stator 1 is distinguished in that a respective current path 8a, 8b forms a combined wave and lap winding, which extends over all the double layers 26a-c.

In FIG. 4, below the upper table, a receiving location occupied by an inner portion 11 is indicated by hatching. Furthermore, connecting portions 9 of the first type are illustrated by dashed arrow connections between two receiving locations, and connecting portions 10 of the second type by continuous arrow connections.

Clearly, each connecting portion 9 of the first type connects inner portions 11, which are arranged in different double layers 26a-c, in series. Each connecting portion 10 connects the inner portion 11, which is arranged in the same double layer 26a-c, in series. In this case, each connecting portion of the second type connects an inner portion 11, which is arranged in an even-numbered layer 25b, 25d, 25f, in series with an inner portion 11, which is arranged in an odd-numbered layer 25a, 25c, 25e and follows the inner portion 11, which is arranged in the even-numbered layer 25b, 25d, 25f, along the predetermined circumferential direction 27a.

Each winding zone 24 is furthermore divided in the circumferential direction into q=3 partial winding zones, namely a first partial winding zone 28a, a second partial winding zone 28b and a third partial winding zone 28c, which each comprise all the layers 25a-f and are named according to their order in a circumferential direction 27b, which here is opposite the predetermined circumferential direction 27a. In this case, the first partial winding 20a, 21a of a respective current path 8a, 8b is arranged in the first partial winding zone 28a, the second partial winding 20b, 21b of a respective current path 8a, 8b is arranged in the second partial winding zone 28b and the third partial winding 20c, 21c of a respective current path 8a, 8b is arranged in the third partial winding zone 28c. Generally speaking, the k-th partial winding is arranged in the k-th partial winding zone for every 1≤k≤q, wherein k is a natural number.

FIG. 4 furthermore shows that the ends 18a, 18b, 19a, 19b of a respective current path 8a, 8b are arranged in adjacent winding zones 24 with respect to the circumferential direction. In addition, the first end 18a of the first current path 8a and the first end 19a of the second current path 8b are arranged in different layers 25a, 25b of the same double layer 26a and in the same slot 6. The second end 18b of the first current path 8a and the second end 19b of the second current path 8b, on the other hand, are arranged in directly adjacent slots 6 and in directly adjacent double layers 26b, 26c. Specifically, the second end of the first current path 8a is arranged in the (L/2)-th layer, i.e. the third double layer 26c, or in the (L−1)-th layer, i.e. the fifth layer 25e. The second end of the first current path 8a is arranged in the second double layer 26b or in the fourth layer 25d.

The current paths 8a, 8b extend from their first end 18a, 19a to their second end 18b, 19b in opposite directions q times, i.e., three times in opposite circumferential directions about the stator core 2. In this case, the first current path 8a extends from its first end 18a to its second end 18b along the predetermined circumferential direction 27a about the stator core 2.

FIG. 5 is a detailed view of a conductor sequence 22a, 22b, 22c of the first type.

Each conductor sequence 22a, 22b, 22c of the first type has L/2=3 pairs, namely a first pair 29a, a second pair 29b and a third pair 29c, of a first of the inner portions 30a, and a second of the inner portions 30b. The pairs 29a, 29b, 29c are named according to their order along the current path. The first and second inner portions 30a, 30b are arranged in different layers 25a-f of the double layer 26a, 26a, 26c corresponding to the naming of the pair 29a, 29b, 29c. This means that the first pair 29a is arranged in the first double layer 26a, that the second pair 29b is arranged in the second double layer 26b, and that the third pair 29c is arranged in the third double layer 26c. In particular, the first inner portion 30a of the first pair 29a is arranged in the second layer 25b, the second inner portion 30b of the first pair 29a is arranged in the first layer 25a, the first inner portion 30a of the second pair 29b is arranged in the fourth layer 25d, the second inner portion 30b of the second pair 29b is arranged in the third layer 25c, the first inner portion 30a of the third pair 29c is arranged in the sixth layer 25f, and the second inner portion 30b of the third pair 29c is arranged in the fifth layer 25e.

The first inner portions 30a of a respective pair 29a, 29b, 29c are located in one of the winding zones 24a and the second inner portions 30b are located in the following winding zone 24b of the same strand U, V, W with respect to the predetermined circumferential direction 27a. The first inner portion 30a of the first pair 29a of the following conductor sequence 22b, 22c with respect to the first current path 8a is located in a winding zone 24c of the same strand U, V, W directly adjacent to the winding zone 24b.

FIG. 6 is a detailed view of a conductor sequence 23a, 23b, 23c of the second type.

The conductor sequences 23a, 23b, 23c of the second type are arranged in first to fourth directly adjacent winding zones 24d-g of the same strand U, V, W. Each conductor sequence 23a, 23b, 23c of the second type has L/2=3 pairs, namely a first pair 31a, a second pair 31b and a third pair 31c, of a first of the inner portions 30c and a second of the inner portions 30d. The pairs 31a, 31b, 31c are named according to their order along the second current path 8b. The inner portions 30c, 30d of a respective pair 31a, 31b, 31c are arranged in different layers 25a-f of the same double layer 26a-c.

The first pair 31a is arranged in the first double layer 26a. The first inner portion 30c is arranged in the first layer 25a and the second inner portion 30d is arranged in the second layer 25b. The second pair 31b is arranged in the (L/2)-th double layer, namely in the third double layer 26c. In this case, the first inner portion 30c is arranged in the fifth layer 25e and the second inner portion 30d is arranged in the sixth layer 25f. The third pair 31c is arranged in the second double layer 26b. In this case, the first inner portion 30c is arranged in the third layer 25c and the second inner portion 30d is arranged in the fourth layer 25d.

The first pair 31a is arranged in the first winding zone 24d and in the second winding zone 24e directly adjacent along the opposite circumferential direction 27b. The second pair 31b and the third pair 31c are arranged in the third winding zone 24f, which is directly adjacent to the second winding zone 24e along the opposite circumferential direction 27b, and in the fourth winding zone 24g, which is directly adjacent to the third winding zone 24f along the opposite circumferential direction 27b.

The third winding zone 24f, in which the inner portions of the first to (P−1)-th conductor sequences 23a, 23b of the second type are arranged, is the first winding zone 24d, in which the conductor sequence 23b, 23c of the first type following the conductor sequence 23a, 23b of the first type with respect to the current path 8b is arranged. The fourth winding zone 24g, in which the inner portions of the first to (P−1)-th conductor sequences 23a, 23b of the second type are arranged, is the second winding zone 23b, in which the conductor sequence 23b, 23c of the second type following the conductor sequence 23a, 23b of the second type with respect to the second current path 8b is arranged.

As can be seen from FIG. 5 and FIG. 6, the inner portions 30a-d of the same pair are 29a, 29b, 29c, 31a, 31b, 31c are connected by connecting portions 10 of the second type. The inner portions 30a-d of different pairs 29a, 29b, 29c, 31a, 31b, 31c are connected by connecting portions 9 of the first type. Consecutive conductor sequences 22a, 22b, 22c, 23a, 23b, 23c are connected by connecting portions 9 of the first type. Again with reference to FIG. 4, it can be seen that consecutive partial windings 20a, 20b, 20c, 21a, 21b, 21c are connected by connecting portions 9 of the first type.

FIG. 7 and FIG. 8 each show a block circuit diagram of the stator winding 7 according to a second and a third exemplary embodiment of a stator 1. All the statements made in respect of the first exemplary embodiment can be applied to these exemplary embodiments, provided nothing to the contrary is described hereinafter.

In the second exemplary embodiment, a single star-point connection 15a is provided. The second ends 18b, 19b of the current paths 8a, 8b of the strands U, V, W are connected to the star-point connection 15a. In the third exemplary embodiment, a single star-point connection 15a is also provided. The second end 18b of the first current path 8a of a respective strand U, V, W is connected here in series with the first end 19b of the second current path 8b of the respective strand U, V, W. The second ends 19b of the second current path 8b are connected to the star-point connection 15b.

Although the stator 1 was described in the preceding exemplary embodiments as a stator with P=3 pole pairs and a number of holes q·=3, such that, for N=3 strands, 2 N P q=54 slots 6 result, a stator 1 according to further exemplary embodiments can also have P=3 pole pairs and a number of holes q=2 or P=2 pole pairs and a number of holes q=2 or P=2 pole pairs and a number of holes q=3 or P=4 pole pairs and a number of holes q=2 or P=4 pole pairs and a number of holes q=3. In each of these exemplary embodiments, the number of layers can be L=6 or L=8 or L=10.

FIG. 9 is a schematic diagram of an exemplary embodiment of a vehicle 100 with an exemplary embodiment of an electrical machine 101.

The electrical machine 101 has a stator 1 according to one of the previously described exemplary embodiments and a rotor 102. The rotor 102 is mounted rotatably with respect to the stator 1 and is designed as a permanently excited or externally excited rotor 102. The electrical machine 101 is a synchronous machine. Alternatively, the electrical machine 101 is an induction machine.

The electrical machine 101 is configured for driving the vehicle 100, which in this respect is a battery-electric vehicle (BEV) or a hybrid vehicle.

1. A stator for an electrical machine, comprising a stator core which has a longitudinal axis, an end side, a further end side opposite the end side and a plurality of slots arranged in the circumferential direction and extending from the end side to the further end side, and a stator winding which has a number N of strands, wherein N≥3, wherein
each strand occupies a plurality of winding zones in the slots and has at least one continuous current path with a first end and with a second end opposite the first end, wherein
each winding zone is radially divided into first to L-th layers, which are named according to their order in the radial direction, wherein
the layers form first to (L/2)-th double layers, wherein the i-th of the double layers comprises the (2i−1)-th of the layers and the (2i)-th of the layers for every 1≤i≤(L/2), wherein L≥4 and is straight,
wherein the j-th of the double layers is offset in relation to the (j−1)-th of the double layers for every 2≤j≤(L/2) by a slot along a predetermined circumferential direction, wherein N, L, i and j are natural numbers,
wherein
each of the current paths forms in each case a combined wave and lap winding extending over all of the double layers.

2. The stator as claimed in claim 1, wherein
each of the current paths is formed in each case by a plurality of connecting portions of the first type, which are arranged on the end side, a plurality of connecting portions of the second type, which are arranged on the further end side, and a plurality of inner portions, which are arranged within the slots and are connected in series by means of the connecting portions.

3. The stator as claimed in claim 2, wherein
each of the connecting portions of the first type connects two inner portions, which are arranged in different double layers, in series.

4. The stator as claimed in claim 2, wherein
each of the connecting portions of the second type connects an inner portion, which is arranged in one of the even-numbered layers, in series with an inner portion, which is arranged in one of the odd-numbered layers and follows the inner portion, which is arranged in the even-numbered layer, along the predetermined circumferential direction or along a circumferential direction opposite the predetermined circumferential direction.

5. The stator as claimed in claim 1, wherein
the respective ends of the respective current paths are arranged in winding zones which are adjacent with respect to the circumferential direction.

6. The stator as claimed in claim 1, wherein
a first and a second current path are provided for each strand.

7. The stator as claimed in claim 6, wherein
the first end of the first current path and the first end of the second current path are arranged in the same slot and/or in different layers of the same double layer, and/or
the second end of the first current path and the second end of the second current path are arranged in different, in particular directly adjacent, slots and/or in different, in particular directly adjacent, double layers.

8. The stator as claimed in claim 6, further comprising
a star-point connection and, for each strand, a phase connection, wherein
the first ends of the current paths of a respective strand are connected to the phase connection for the respective strand and
the second end of a respective current path of a respective strand is connected to the star-point connection, or
the second end of the first current path of a respective strand is connected to the star-point connection, and the stator has a further star-point connection to which the second end of the second current path of a respective strand is connected;
or
the current paths of a respective strand are connected in series, one of the ends of the first current path of a respective strand is connected to the phase connection for the strand and one of the ends of the second current path of the respective strand is connected to the star-point connection.

9. The stator as claimed in claim 6, wherein
the first current path and the second current path extend from the first end to the second end in opposite circumferential directions about the stator core.

10. The stator as claimed in claim 2, wherein
each winding zone is divided in the circumferential direction into first to q-th partial winding zones which each comprise all of the layers and are named according to their order in the circumferential direction, in particular their order counter to the predetermined circumferential direction, and the current path has first to q-th partial windings, which are connected in series in the order of their naming, wherein q≥2 and is a natural number, wherein the partial windings are arranged in different partial winding zones, in particular the k-th partial winding in the k-th partial winding zone for every 1≤k≤q, wherein k is a natural number.

11. The stator as claimed in claim 10, wherein
each partial winding forms a full revolution about the stator core.

12. The stator as claimed in claim 10, wherein
in one of the minimum of one current path, a respective partial winding comprises a set of first to P-th conductor sequences of the first type, which follow one another in the order of their naming with respect to the current path and are arranged in each case in two directly adjacent winding zones, wherein
each conductor sequence of the first type comprises first to (L/2)-th pairs of a first of the inner portions and a second of the inner portions and the pairs are named according to their order along the current path, wherein
the first and second inner portions are arranged in different layers of the double layer corresponding to the naming of the pair, wherein
the first to (P−1)-th conductor sequences of the first type are connected by one of the connecting portions, in particular the connecting portions of the first type, to the conductor sequence of the first type following along the current path and the following conductor sequence of the first type is arranged in two directly adjacent winding zones.

13. The stator as claimed in claim 10, wherein
in one of the minimum of one current path, a respective partial winding comprises a set of first to P-th conductor sequences of the second type, which follow one another in the order of their naming with respect to the current path and are arranged in each case in first to fourth directly adjacent winding zones, wherein
each conductor sequence of the second type comprises first to (L/2)-th pairs of a first of the inner portions, and a second of the inner portions, and the pairs are named according to their order along the current path, wherein
the first and second inner portions are arranged in different layers of the same double layer, wherein
the first pair is arranged in the first double layer, wherein
the second pair is arranged in the (L/2)-th double layer, wherein
the third pair is arranged in the second double layer or the third to (L/2)-th pairs are arranged in the second to [(L/2)−1]-th double layer, wherein
the third winding zone, in which the inner portions of the first to (P−1)-th conductor sequences of the second type are arranged, is the first winding zone, in which the conductor sequence following the conductor sequence with respect to the current path is arranged, wherein
the fourth winding zone, in which the inner portions of the first to (P−1)-th conductor sequences of the second type are arranged, is the second winding zone, in which the conductor sequence of the second type following the conductor sequence with respect to the current path is arranged.

14. An electrical machine, comprising a stator as claimed in claim 1 and a rotor mounted rotatably relative to the stator.

15. A vehicle, comprising an electrical machine as claimed in claim 14, wherein the electrical machine is configured for driving the vehicle.

16. The stator as claimed in claim 1, wherein
each winding zone is divided in the circumferential direction into first to q-th partial winding zones which each comprise all of the layers and are named according to their order in the circumferential direction, in particular their order counter to the predetermined circumferential direction, and the current path has first to q-th partial windings, which are connected in series in the order of their naming, wherein q≥2 and is a natural number, wherein the partial windings are arranged in different partial winding zones, in particular the k-th partial winding in the k-th partial winding zone for every 1≤k≤q, wherein k is a natural number.

17. The stator as claimed in claim 3, wherein
each of the connecting portions of the second type connects an inner portion, which is arranged in one of the even-numbered layers, in series with an inner portion, which is arranged in one of the odd-numbered layers and follows the inner portion, which is arranged in the even-numbered layer, along the predetermined circumferential direction or along a circumferential direction opposite the predetermined circumferential direction.

18. The stator as claimed in claim 2, wherein
the respective ends of the respective current paths are arranged in winding zones which are adjacent with respect to the circumferential direction.

19. The stator as claimed in claim 2, wherein
a first and a second current path are provided for each strand.

20. The stator as claimed in claim 19, wherein
the first end of the first current path and the first end of the second current path are arranged in the same slot and/or in different layers of the same double layer, and/or
the second end of the first current path and the second end of the second current path are arranged in different, in particular directly adjacent, slots and/or in different, in particular directly adjacent, double layers.
